(19) United States
(12) Patent Application Publication
(10) Pub. No.: US 2003/0065576 A1
(43) Pub. Date: Apr. 3, 2003

(54) Transmitting a file to a customer possessing a hand held computer by a point of sale terminal

(75) Inventors: Richard Hunter Harris, Raleigh, NC (US); Thomas Joseph Prorock, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 09/970,361

(22) Filed: Oct. 2, 2001

(51) Int. Cl. G06F 17/60

(52) U.S. Cl. 705/26

(57) ABSTRACT

A method, system and computer program product for transmitting customized URL's to a customer in a point of sale system. A point of sale terminal may transmit customized URL(s) to a hand held computer possessed by the customer that may be determined to be of interest to the customer. The URL(s) that may be of interest to the customer may be determined at least in part based on past or present customer transactions, profile of the customer, responses to previously transmitted URL(s) and items to promote. The customized URL(s) transmitted to the customer may then be tracked. Based on tracking the effectiveness of the URL(s), a marketing/advertising strategy may be developed, a profile of the customer may be edited, and a negotiation may occur with an entity to distribute one or more URL(s) identifying that identity to the customer.

### TECHNICAL FIELD

The present invention relates to the field of point of sale systems, and more particularly to a point of sale terminal transmitting one or more Uniform Resource Locator's (URL's) in a file to a customer possessing a hand held computer, e.g., Personal Digital Assistant (PDA), palmtop, smart phone, Pocket PC.

### BACKGROUND INFORMATION

Face to face retail sales transactions take place at the point of sale or what is commonly referred to as the checkout line or counter. It is at this location that the customer pays for the goods purchased, typically by either cash, check, credit or debit card. To effectuate the sale, many retailers presently use electronic devices to facilitate and provide a record of transactions. Such a point of sale system may include a scanner for reading coded product information, a terminal for manual entry of transaction information and storage of currency, a display for displaying transaction information and a printer which may be used to produce a documentary record or journal for the business and a printed receipt for the customer. A point of sale system may further include a database that may be configured to store what are commonly referred to as customer profiles. A customer profile may refer to a profile of information about a particular customer such as the particular goods purchased, coupons tendered, the amounts purchased for each transaction, etc.

Retailers recently have provided what are commonly referred to as “loyalty cards” to their customers. A loyalty card may refer to a customer identification card that identifies the customer to the retailer. Typically, the customer or the cashier may swipe the loyalty card into a card reader, e.g., magnetic strip reader, bar code reader, that may be provided in the point of sale system. Upon identifying the customer, the customer may receive free goods, a discount such as based on the total amount purchased, etc. Furthermore, upon identifying the customer, the customer's profile may be updated based on the transaction.

Today many customers of retailers possess hand held computers, e.g., Personal Digital Assistant (PDA), palmtop, smart phone, Pocket PC, that have the capability of accessing the Internet. Users of hand held computers may be linked to the Internet through the a hypertext system of servers commonly referred to as the World Wide Web (“WWW”). With the World Wide Web, an entity having a domain name may create a “web page” or “page” than can provide information and to some degree interactivity.

The computer user may “browse”, i.e. navigate around, the WWW by utilizing a suitable web browser, e.g., Netscape Navigator™, Internet Explorer™, stored on the hand held computer, and a network gateway, e.g., Internet Service Provider (ISP). A web browser may allow the computer user to specify or search for a web page on the WWW and subsequently retrieve and display web pages on the user's computer screen.

A computer user may access a particular web page by entering a particular Uniform Resource Locator (URL) in the browser's location edit field. Typically, a URL may comprise the protocol prefix, domain name, subdirectory names and a file name. For example, in the URL http://www.InternetBookStore.com/BookOfTheMonth/Fiction02-2001.html, the protocol prefix is “http”, the domain name is “www.InternetBookStore.com,” the subdirectory name is “BookOfTheMonth,” and the file name is Fiction02-2001.html.” URL names may be very long and complex making them difficult to remember and easy to enter incorrectly in the browser's location edit field. Subsequently, entities that provide business through their web page rely on the user entering the appropriate URL name correctly.

Customers may desire to receive URL's that link to particular web pages illustrating goods or services of interest. As stated above, a customer profile may store information about the particular customer such as particular goods purchased, coupons tendered, the amounts purchased for each transaction, etc.

It would therefore be desirable to use information stored in a customer profile and determine particular URL(s) that are of interest to the customer. It would further be desirable to transmit the particular URL(s) that are of interest to the customer to the customer's hand held device thereby enabling the customer to access particular web pages of interest without the difficulty of remembering and entering correctly the URL(s) in the browser's location edit field. It would further be desirable to track the effectiveness of the customized URL(s) and formulate advertising/marketing strategies based on tracking the effectiveness of the customized URL(s).

### SUMMARY

The problems outlined above may at least in part be solved in some embodiments by determining particular Uniform Resource Locator's (URL's) that might be of interest to the customer and transmitting those URL(s) to a hand held computer, e.g., Personal Digital Assistant (PDA), palmtop, smart phone, Pocket PC, possessed by the customer by a point of sale terminal, e.g., cash register. Upon transmitting URL(s) to the hand held computer possessed by the customer, the effectiveness of those URL(s) may be tracked. Based on tracking the effectiveness of the URL(s), a marketing/advertising strategy may be developed. Furthermore, based on tracking the effectiveness of the URL(s), a negotiation may occur with an entity to distribute one or more URL(s) identifying that identity to the customer. Furthermore, based on tracking the effectiveness of the URL(s), a profile of the customer may be edited.

In one embodiment of the present invention, a method for transmitting customized URL's to a customer in a point of sale system may comprise the step of receiving input from a customer identification card, e.g., loyalty card. The customer may swipe the customer identification card into a card reader, e.g., magnetic strip reader, bar code reader, in the point of sale system that identifies the customer at the point of sale. A request may then be transmitted to a server by the point of sale terminal to search for the customer profile associated with the customer in a database. The server may then transmit the customer profile associated with the customer to the point of sale terminal. Upon receiving the customer profile, the point of sale terminal may read the customer profile. In one embodiment, the customer profile may comprise information, e.g., host name, port number of the hand held computer of the customer, that enables the point of sale terminal to establish a connection with the hand held computer of the customer.

In an alternative embodiment, a connection may be established by the point of sale terminal and the hand held computer of the customer by the point of sale terminal receiving a request with an appropriate identifier from the hand held computer to establish a connection. The appropriate identifier may identify a particular point of sale terminal. For example, a particular point of sale terminal such as a cash register may be identified by a port number along with a terminal number.

A determination may then be made as to which URL(s) to include in a file, e.g., bookmark file, that may be of interest to the customer. These customized URL(s) may be determined at least in part based on past or present customer transactions. For example, the items purchased by the customer in the current sales transaction or in prior sales transactions may be used to determine which URL's, e.g., URL for a pair of name brand athletic shoes on sale at the store, would be of interest to the customer. The customized URL(s) may be determined at least in part based on the customer's profile. For example, the customer profile may include a shopping history of the customer, a profile of interests completed by the customer, manufacturing coupons redeemed in the past, etc. The customized URL(s) may be determined at least in part based on the customer's response to previously transmitted customized URL(s). For example, if the customer did not respond to particular URL(s) previously transmitted, those URL(s) may not be re-transmitted to the customer. In another example, if the customer responded to URL(s) in the area of sporting goods, then one or more URL's may be transmitted in this particular area. The customized URL(s) may be determined at least in part based on the items to promote. For example, the store may be currently engaged in a promotional advertising campaign. In another example, the store may have an alliance or a business partnership with another entity that may want to promote their items.

The customized URL(s) that may be of interest to the customer may be transmitted to the hand held computer of the customer by the point of sale terminal. The effectiveness of the customized URL(s) transmitted to the hand held computer of the customer may then be tracked. Based on tracking the effectiveness of the URL(s), a marketing/advertising strategy may be developed. Furthermore, based on tracking the effectiveness of the URL(s), a negotiation may occur with an entity to distribute one or more URL(s) identifying that identity to the customer. Furthermore, based on tracking the effectiveness of the URL(s), a profile of the customer may be edited.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a point of sale system configured in accordance with the present invention;

FIG. 2 illustrates an embodiment of the present invention of a point of sale terminal in a point of sale system;

FIG. 3 illustrates an embodiment of the present invention of a hand held computer in a point of sale system;

FIG. 4 illustrates an embodiment of the present invention of a server in a point of sale system; and

FIG. 5 is a flowchart of a method for transmitting Uniform Resource Locator's (URL's) to a hand held computer possessed by a customer in accordance with the present invention.

### DETAILED DESCRIPTION

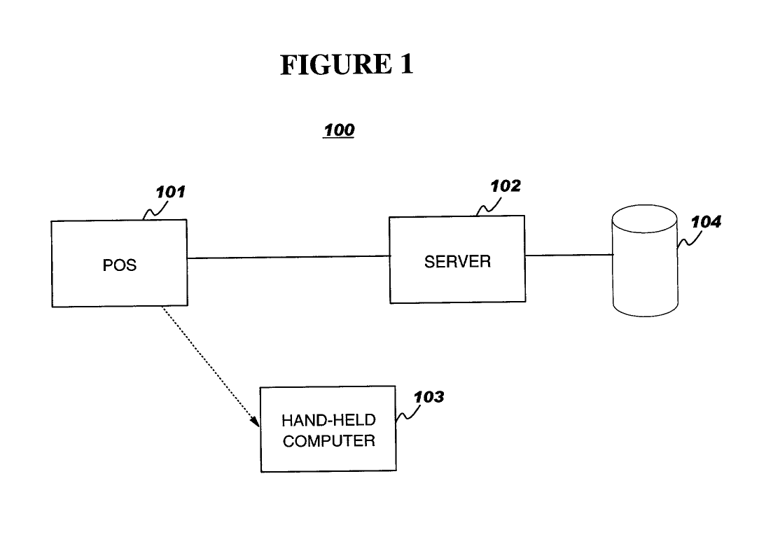

FIG. 1—Point of Sale System

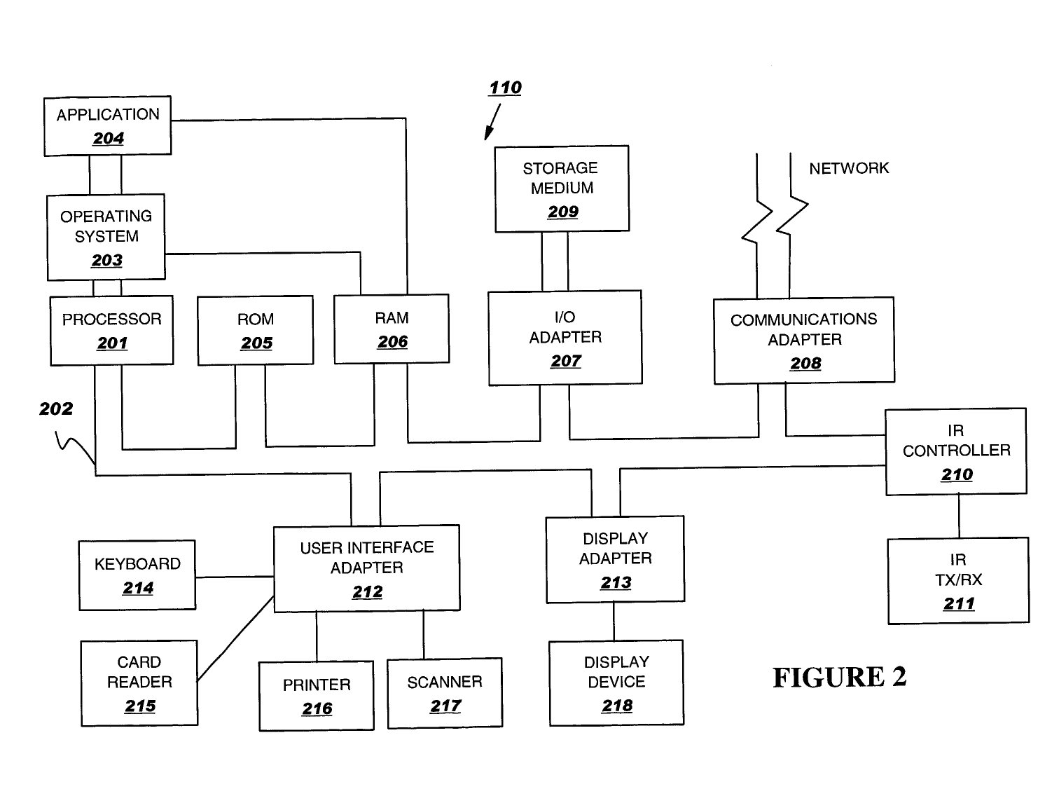

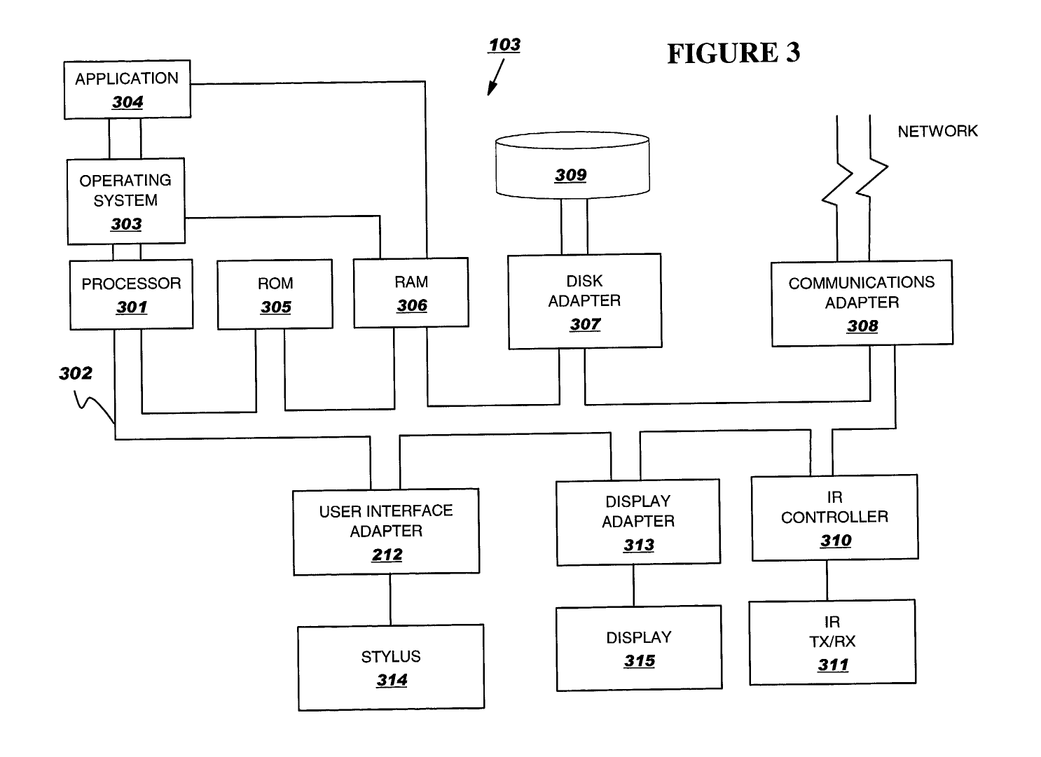

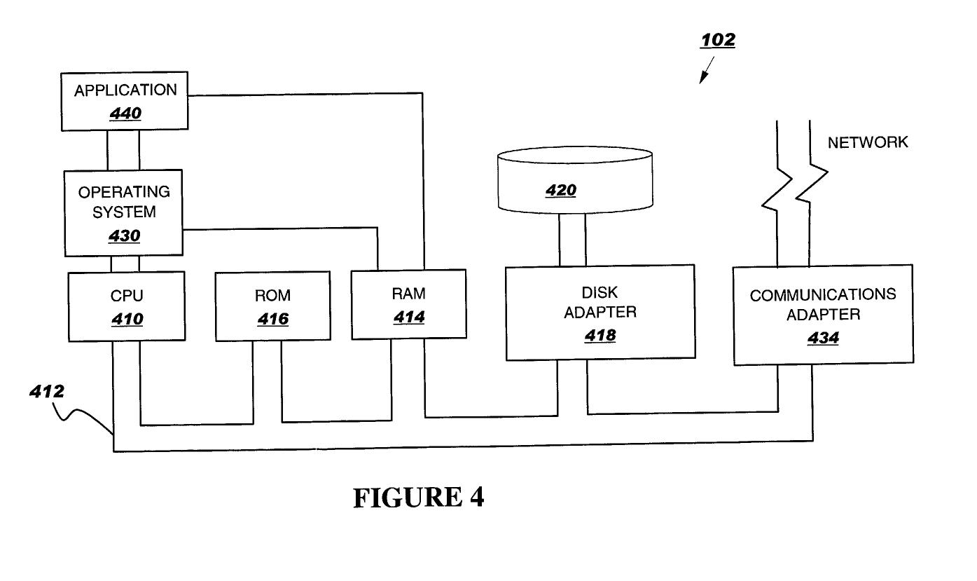

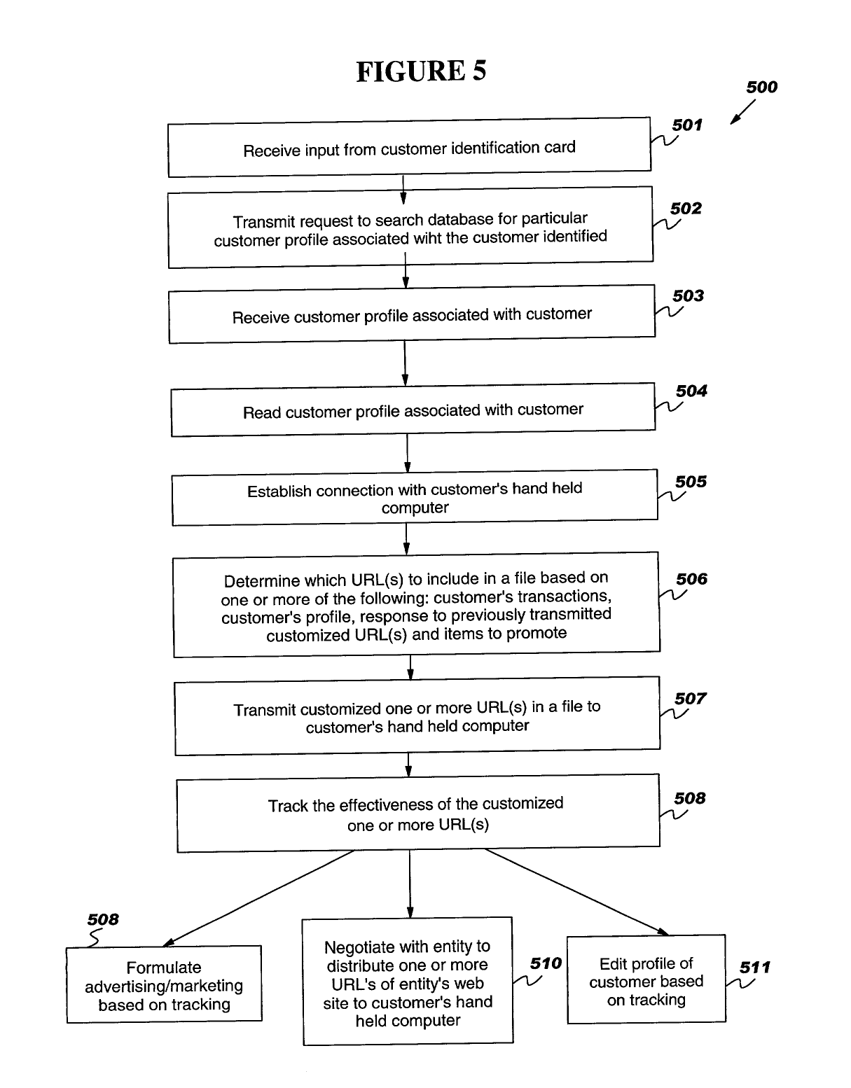

FIG. 1 illustrates one embodiment of the present invention of a point of sale system 100. Point of sale system 100 may comprise a point of sale terminal 101, e.g., cash register, kiosk, pump system, coupled to a server 102, e.g., web server. Server 102 may be configured to maintain a database 104 configured to store a plurality of customer profiles. A customer profile may refer to a profile of information about a particular customer such as the particular goods purchased, coupons tendered, the amounts purchased for each transaction, etc. Point of sale terminal 101 may be configured to calculate the total price of a purchase, the amount of change due to a customer as well as be configured to generate, correlate, organize and transmit one or more customized Uniform Resource Locator's (URL's), in the form of a file, to a hand held computer 103, e.g., Personal Digital Assistant (PDA), palmtop, smart phone, Pocket PC, possessed by a customer as described in greater detail in conjunction with FIG. 5. A more detailed description of point of sale terminal 101 is described in conjunction with FIG. 2. A more detailed description of hand held computer 103 is described in conjunction with FIG. 3. A more detailed description of server 102 is described in conjunction with FIG. 4. It is noted that point of sale system 100 may comprise any number of point of sale terminals 101, servers 102 and hand held computers 103 and that FIG. 1 is illustrative. It is further noted that the connection between point of sale terminal 101 and server 102 may be any medium type, e.g., wireless, wired. It is further noted that the connection between point of sale terminal 101 and hand held computer 103 may be any medium type, e.g., wireless such as infrared transmission, wired. It is further noted that point of sale system 100 may be any type of system that has at least one point of sale terminal, at least one server and at least one hand held computer server and that FIG. 1 is not to be limited in scope to any one particular embodiment.

FIG. 2—Point of Sale Terminal

FIG. 2 illustrates an embodiment of the present invention of point of sale terminal 101. Point of sale terminal 101 may comprise a processor 201 coupled to various other components by a bus 202. An operating system 203 may run on processor 201 and provide control as well as coordinate the function of the various components of FIG. 2. Application 204, e.g., program for transmitting one or more customized URLs to a hand held computer possessed by a customer as described in FIG. 5, may run in conjunction with operating system 203 which implements the various functions to be performed by application 204. Point of sale terminal 101 may further comprise a Read only memory (ROM) 205 coupled to bus 202 and may include a basic input/output system (“BIOS”) that controls certain basic functions of point of sale terminal 101. Random access memory (RAM) 206, Input/Output (I/O) adapter 207 and communications adapter 208 may also coupled to bus 202. It should be noted that software components including operating system 203 and application 204 may be loaded into RAM 206 which may be point of sale terminal's 101 main memory. I/O adapter 207 may be an integrated drive electronics (“IDE”) adapter that communicates with a storage medium 209, e.g., disk drive. It is noted that the program of the present invention that transmits one or more customized URLs to a hand held computer possessed by a customer as described in FIG. 5 may reside in storage medium 209 or in application 204. Communications adapter 208 may interconnect bus 202 with an outside network enabling point of sale terminal 101 to communicate with server 102 or hand held computer 103 via a Local Area Network (LAN), e.g., Ethernet, Token Ring, ARCnet, or a Wide Area Network (WAN), e.g., Internet.

Point of sale terminal 101 may further comprise an Infrared (IR) controller 210 coupled to bus 202. IR controller 210 may be a dedicated controller configured for processing an infrared code transmitted/received by an IR transceiver 211 and for capturing the same as data. Subsequently, point of sale terminal 101 may communicate with hand held computer 103, e.g., transmit one or more customized URL's to hand held computer 103, via infrared transmission.

Point of sale terminal 101 may further comprise Input/Output (I/O) devices that may be coupled to bus 202 via a user interface adapter 212 and a display adapter 213. Keyboard 214, card reader 215, e.g., magnetic strip reader, bar code reader, printer 216 and scanner 217 may all be interconnected to bus 202 through user interface adapter 212. Card reader 215 may be used for reading information on a customer identification card such as a loyalty card. Printer 216 may be used for printing receipts, coupons and vouchers as directed by processor 201. Scanner 217 may be used for scanning information on bar codes such as on coupons as well as reading information on a customer identification card. A display device 218 may be coupled to bus 202 through display adapter 213. Display device 218 may be used for displaying alphanumeric characters, e.g., listing of the items purchased along with the purchase price of each item, to the cashier and/or customer. In this manner, a user may be capable of inputting to point of sale terminal 101 through keyboard 214, card reader 215, scanner 217 and receiving output from point of sale terminal 101 via printer 216 or display device 218. It is noted that there are numerous types of input devices, printers and display devices known to those skilled in the art and thus need not be described in detail herein.

Implementations of the invention include implementations as a point of sale terminal programmed to execute the method or methods described herein, and as a computer program product. According to the point of sale terminal implementation, sets of instructions for executing the method or methods may be resident in the random access memory 206 of one or more point of sale terminal systems configured generally as described above. Until required by the point of sale terminal, the set of instructions may be stored as a computer program product in another memory, for example, in storage medium 209 (which may include a removable memory such as an optical disk or floppy disk for eventual use in the storage medium 209). Further, the computer program product may also be stored at another point of sale terminal and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological or some other physical change.

FIG. 3—Hand Held Computer

FIG. 3 illustrates an embodiment of the present invention of hand held computer 103, e.g., PDA, palmtop, smart phone, Pocket PC, possessed by a customer. Hand held computer 103 may comprise a processor 301 coupled to various other components by a bus 302. An operating system 303 may run on processor 301 and provide control as well as coordinate the function of the various components of FIG. 3. An application 304 in accordance with the principles of the present invention may run in conjunction with operating system 303 and provides output calls to operating system 303 where the output calls implement the various functions or services to be performed by application 304. Application 304 may include for example, program for establishing a connection with point of sale terminal 101. Read only memory (ROM) 305 may be coupled to bus 302 and include a Basic Input/Output System (“BIOS”) that controls certain basic functions of hand held computer 103. Random access memory (RAM) 306, Disk adapter 307, and communications adapter 308 may also be coupled to bus 302. It should be noted that software components including operating system 303 and application 304 may be loaded into RAM 306 which may be the hand held computer's 103 main memory. Disk adapter 307 may be an integrated drive electronics (“IDE”) adapter that communicates with disk unit 309, e.g., disk drive. It is noted that the program of the present invention establishes a connection with point of sale terminal 101 as described in FIG. 5 may reside in disk unit 309 or in application 304. Communications adapter 308 may interconnect bus 302 with an outside network enabling hand held computer 103 to communicate with point of sale terminal 101 via a Local Area Network (LAN), e.g., Ethernet, Token Ring, ARCnet, or a Wide Area Network (WAN), e.g., Internet.

Hand held computer 103 may further comprise an Infrared (IR) controller 310 coupled to bus 302. IR controller 310 may be a dedicated controller configured for processing an infrared code transmitted/received by an IR transceiver 311 and for capturing the same as data. Subsequently, hand held computer 103 may communicate with point of sale terminal 101, e.g., receive one or more customized URL's from point of sale terminal 101, via infrared transmission.

Input/Output devices may also be connected to bus 302 via a user interface adapter 312 and display adapter 313. A stylus 314 may be connected to bus 302 through user interface adapter 312. A display 315 may be connected to bus 302 by display adapter 313. In this manner, a user may be capable of inputting to hand held computer 103 through stylus 314 and receiving output from hand held computer 103 via display 315.

Implementations of the invention include implementations as a computer system programmed to execute the method or methods described herein, and as a computer program product. According to the computer system implementation, sets of instructions for executing the method or methods are resident in the random access memory 306 of one or more computer systems configured generally as described above. Until required by the hand held computer, the set of instructions may be stored as a computer program product in another computer memory, for example, in disk drive 309 (which may include a removable memory such as an optical disk or floppy disk for eventual use in the disk drive 309). Further, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change.

FIG. 4—Hardware Configuration of Server

FIG. 4 illustrates an embodiment of the present invention of server 102. Referring to FIG. 4, server 102 may comprise a central processing unit (CPU) 410 coupled to various other components by system bus 412. An operating system 430 may run on CPU 410 and provide control as well as coordinate the function of the various components of FIG. 4. An application 440 in accordance with the principles of the present invention may run in conjunction with operating system 430 and provide output calls to operating system 430 where the output calls implement the various functions or services to be performed by application 440. An application 440 may include, for example, a program for maintaining and editing customer profiles in database 104 (FIG. 1), a program for determining which URL(s) to transmit, a program for tracking the effectiveness of the customized one or more URL's transmitted to hand held computer 103 of the customer. Read only memory (ROM) 416 may be coupled to system bus 412 and include a Basic Input/Output System (“BIOS”) that controls certain basic functions of server 102. Random access memory (RAM) 414, disk adapter 418 and communications adapter 434 may also be coupled to system bus 412. It should be noted that software components including operating system 430 and application 440 may be loaded into RAM 414 which may be the computer system's main memory. Disk adapter 418 may be a small computer system interface (“SCSI”) adapter that communicates with disk units 420, e.g., disk drive. It is noted that the program of the present invention that tracks the effectiveness of the one or more customized URL's transmitted to a hand held computer possessed by a customer as described in FIG. 5 may reside in disk drive 420 or in application 440. It is further noted that the program of the present invention that determines which URL(s) to transmit as described in FIG. 5 may reside in disk drive 420 or in application 440. It is further noted that the program of the present invention that maintains and edits customer profiles in database 104 as described in FIG. 5 may reside in disk drive 420 or in application 440. Communications adapter 434 may interconnect bus 412 with an outside network enabling server 102 to communicate with point of sale terminal 101 via a Local Area Network (LAN), e.g., Ethernet, Token Ring, ARCnet, or a Wide Area Network (WAN), e.g., Internet.

Implementations of the invention include implementations as a computer system programmed to execute the method or methods described herein, and as a computer program product. According to the computer system implementations, sets of instructions for executing the method or methods may be resident in the random access memory 414 of one or more computer systems configured generally as described above. Until required by server 102, the set of instructions may be stored as a computer program product in another computer memory, for example, in disk drive 420 (which may include a removable memory such as an optical disk or floppy disk for eventual use in disk drive 420). Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 5—Method for Transmitting URL's to Hand Held Computer Possessed by Customer

FIG. 5 illustrates a flowchart of one embodiment of the present invention of a method 500 for transmitting one or more customized URL's to hand held computer 103 possessed by a customer. As stated in the Background Information section, customers may desire to receive URL's that link to particular web pages illustrating goods or services of interest. As stated above, a customer profile may store information about the particular customer such as particular goods purchased, coupons tendered, the amounts purchased for each transaction, etc. It would be desirable to use information stored in a customer profile and determine particular URL(s) that are of interest to the customer. It would further be desirable to transmit the particular URL(s) that are of interest to the customer to the customer's hand held device thereby enabling the customer to access particular web pages of interest without the difficulty of remembering and entering correctly the URL(s) in the browser's location edit field. It would further be desirable to track the effectiveness of the customized URL(s) and formulate advertising/marketing strategies based on tracking the effectiveness of the customized URL(s). Method 500 is a method for transmitting particular URL(s) that are of interest to the customer to the customer's hand held device. Method 500 is a method for tracking the effectiveness of the customized URL(s) and formulating advertising/marketing strategies based on tracking the effectiveness of the customized URL(s).

In step 501, an input such as a customer identification may be received from a customer identification card, e.g., loyalty card. In one embodiment, the customer or cashier may swipe the customer identification card into card reader 215 (FIG. 2), e.g., magnetic strip reader, bar code reader, to identify the customer at the point of sale.

In step 502, a request may be transmitted to server 102 (FIG. 4) to search database 104 (FIG. 1) for a particular customer profile that is associated with the customer identified in step 501. In step 503, a customer profile associated with the customer identified in step 501 may be received. In one embodiment, upon locating the customer profile associated with the customer identified in step 501, server 102 may transfer the located customer profile to point of sale terminal 101.

In step 504, the customer profile received in step 503 may be read. In one embodiment, the customer profile received in step 503 may comprise information, e.g., host name, port number of hand held computer 103 (FIG. 3) of the customer identified in step 501, that enables point of sale terminal 101 to establish a connection with hand held computer 103 of the customer.

In step 505, a connection may be established between point of sale terminal 101 and hand held computer 103 of the customer identified in step 501. In one embodiment, point of sale terminal 101 may transmit a request to establish a connection to hand held computer 103 where the hand held computer 103 may be configured to receive such a request on a predetermined port as identified in the customer profile read in step 504. In an alternative embodiment, point of sale terminal 101 may receive a request with an appropriate identifier from hand held computer 103 to establish a connection with hand held computer 103 of the customer identified in step 501. Hand held computer 103 may be configured to transmit a request to the appropriate point of sale terminal 101, e.g., cash register, kiosk, pump station, based on the identifier associated with that point of sale terminal 101. For example, a particular point of sale terminal 101 such as a cash register in a grocery store may be identified by a port number along with a terminal number. In one embodiment, hand held computer 103 may receive an input from the customer as to the terminal number associated with point of sale terminal 101. Upon receiving the request to establish a connection, a connection may be established between point of sale terminal 101 and hand held computer 103 of the customer identified in step 501.

In step 506, a determination may be made as to the one or more customized URL's to include in a file, e.g., bookmark file, that may be of interest to the customer. In one embodiment, the determination step may be executed by point of sale terminal 101. In another embodiment, the determination step may be executed by server 102. The one or more customized URL's may be determined at least in part based on past or present customer transactions. For example, the items purchased by the customer in the current sales transaction or in prior sales transactions may be used to determine which URL's, e.g., URL for a pair of name brand athletic shoes on sale at the store, would be of interest to the customer. The one or more customized URL's may be determined at least in part based on the customer's profile received in step 503. For example, the customer profile may include a shopping history of the customer, a profile of interests completed by the customer, manufacturing coupons redeemed in the past, etc. The one or more customized URL's may be determined at least in part based on the customer's response to previously transmitted customized URL(s). For example, if the customer did not respond to particular URL(s) previously transmitted, those URL(s) may not be re-transmitted to the customer. In another example, if the customer responded to URL(s) in the area of sporting goods, then one or more URL's may be transmitted in this particular area. The one or more customized URL's may be determined at least in part based on the items to promote. For example, the store may be currently engaged in a promotional advertising campaign. In another example, the store may have an alliance or a business partnership with another entity that may want to promote their items.

In step 507, the customized one or more URL's identified in step 506 in a file, e.g., bookmark file, may be transmitted to hand held computer 103 of the customer identified in step 501. In one embodiment, point of sale terminal 101 may transmit the one or more customized URL's in a file to hand held computer 103 of the customer upon determining the one or more customized URL's to transmit in step 506. The file may be transmitted though any type of medium, e.g., wireless such as infrared transmission, wired. In another embodiment, server 102 may transmit the one or more customized URL's in a file to point of sale terminal 101 upon determining the one or more customized URL's to transmit in step 506. Point of sale terminal 101 may then transmit the received file of customized URL(s) to hand held computer 103 of the customer identified in step 501. As stated above, the file may be transmitted though any type of medium, e.g., wireless such as infrared transmission, wired. Once the file, e.g., bookmark file, has been received by hand held computer 103 of the customer identified in step 501, the customer may later synchronize the file with a personal computer at home. Subsequently, the one or more customized URL's in the file may be accessed by the customer identified in step 501 via hand held computer 103 or via a personal computer at home.

In step 508, the effectiveness of the customized URL(s) transmitted to hand held computer 103 of the customer identified in step 501 may be tracked. In one embodiment, the effectiveness of the customized URL(s) transmitted to hand held computer 103 of the customer identified in step 501 may be tracked by server 102. In one embodiment, each URL transmitted to hand held computer 103 of the customer in step 507 may comprise a customer identification. For example, the URL may be in the following format: www.domain name of the store.date.time stamp.customer identification.particular ad. By configuring URL's in this manner, a store may be able to track the effectiveness of the URL's transmitted to a customer for that customer as well as customers in general. One method for analyzing the effectiveness of URL's is described in a reference entitled “Analysis and Visualization of Metrics for Online Advertising” by Juhnyoung Lee, et al., November 1999. Another method for analyzing the effectiveness of URL's is described in a reference entitled “E-Commerce Intelligence: Measuring, Analyzing and Reporting on Merchandising Effectiveness of Online Stores, by Juhnyoung Lee, et al., July 1999. It is noted that there are other methods for analyzing the effectiveness of URL's. It is further noted that these methods would be recognized by a person of ordinary skill in the art and that such embodiments employing such methods would fall within the scope of the present invention.

Based on tracking the effectiveness of the customized URL(s) transmitted to hand held computer 103 of the customer identified in step 501, method 500 may proceed to one of three steps. Based on tracking the effectiveness of the customized URL(s) transmitted to hand held computer 103 of the customer identified in step 501, a marketing/advertising strategy may be formulated in step 509. For example, a store may be able to better select the items that should appear in a sales brochure. In another example, a store may be able to determine which items are the best selling items and to ensure that there are enough of those items in the stores.

Based on tracking the effectiveness of the customized URL(s) transmitted to hand held computer 103 of the customer identified in step 501, a negotiation may occur with an entity to distribute one or more URL's identifying that entity to the customer in step 510. For example, if a store determines that URL's for a particular brand of shoes have been very effective, the store may negotiate with the company that produces that particular brand of shoes to transmit URL's of that company's web site to the customer's hand held computer.

Based on tracking the effectiveness of the customized URL(s) transmitted to hand held computer 103 of the customer identified in step 501, the profile of the customer identified in step 501 may be edited in step 511. For example, the profile of the customer may be edited to reflect particular URL's that were or were not effective.

It is noted that steps 501-507 may be implemented by the program residing in point of sale terminal 101. It is noted that the alternative embodiment discussed in step 505 may be implemented by the program residing in hand held computer 103. It is noted that steps 506, 508 and 511 may be implemented the program residing in server 102.

It is noted that method 500 may be executed in a different order presented and that the order presented in the discussion of FIG. 5 is illustrative. It is further noted that certain steps may be executed almost concurrently.

Although the system, computer program product and method are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for transmitting customized Uniform Resource Locator's (URL's) to a customer in a point of sale system comprising the steps of:
receiving input from a customer identification card;
receiving a profile on a customer associated with said customer identification card;
reading said profile on said customer;
determining one or more customized URL's to include in a file; and
transmitting said file to a hand held computer possessed by said customer.

2. The method as recited in claim 1, wherein said determination step is based on one or more of the following: transactions of said customer, said profile on said customer, response to previously transmitted one or more customized URL's and items to promote.

3. The method as recited in claim 1 further comprising the step of:
retrieving information from said profile on said customer; and
establishing a connection with said hand held computer possessed by said computer in response to said retrieved information.

4. The method as recited in claim 1 further comprising the step of:
receiving a request with an appropriate identifier to establish a connection with said hand held computer possessed by said customer.

5. The method as recited in claim 4, wherein said appropriate identifier specifies a particular point of sale terminal, wherein said appropriate identifier comprises a port number and a terminal number.

6. The method as recited in claim 1 further comprising the step of:
tracking an effectiveness of said one or more customized URL's.

7. The method as recited in claim 6 further comprising the step of:
formulating a marketing strategy in response to said tracking step.

8. The method as recited in claim 6 further comprising the step of:
negotiating to distribute one or more URL's to said customer in response to said tracking step.

9. The method as recited in claim 6 further comprising the step of:
editing said profile of said customer in response to said tracking step.

10. The method as recited in claim 1, wherein said one or more customized URL's comprise an identification of said customer.

11. A computer program product having a computer readable medium having computer program logic recorded thereon for transmitting customized Uniform Resource Locator's (URL's) to a customer in a point of sale system comprising the steps of:
programming operable for receiving input from a customer identification card;
programming operable for receiving a profile on a customer associated with said customer identification card;
programming operable for reading said profile on said customer;
programming operable for determining one or more customized URL's to include in a file; and
programming operable for transmitting said file to a hand held computer possessed by said customer.

12. The computer program product as recited in claim 11, wherein said determination step is based on one or more of the following: transactions of said customer, said profile on said customer, response to previously transmitted one or more customized URL's and items to promote.

13. The computer program product as recited in claim 11 further comprises:
programming operable for retrieving information from said profile on said customer; and
programming operable for establishing a connection with said hand held computer possessed by said computer in response to said retrieved information.

14. The computer program product as recited in claim 11 further comprises:
programming operable for receiving a request with an appropriate identifier to establish a connection with said hand held computer possessed by said customer.

15. The computer program product as recited in claim 14, wherein said appropriate identifier specifies a particular point of sale terminal, wherein said appropriate identifier comprises a port number and a terminal number.

16. The computer program product as recited in claim 11 further comprises:
programming operable for tracking an effectiveness of said one or more customized URL's.

17. The computer program product as recited in claim 16 further comprises:
programming operable for editing said profile of said customer in response to said tracking step.

18. The computer program product as recited in claim 11, wherein said one or more customized URL's comprise an identification of said customer.

19. A system, comprising:
a server configured to manage a database storing a plurality of profiles on a plurality of customers; and
a point of sale terminal coupled to said server, wherein said point of sale terminal comprises:
a processor; and
a memory unit coupled to said processor, wherein said memory unit is operable for storing a computer program operable for transmitting customized Uniform Resource Locator's (URL's) to a customer in a point of sale system, wherein the computer program is operable for performing the following programming steps:
receiving input from a customer identification card;
receiving a profile on a customer associated with said customer identification card;
reading said profile on said customer;
determining one or more customized URL's to include in a file; and
transmitting said file to a hand held computer possessed by said customer.

20. The system as recited in claim 19, wherein said programming step of determining said one or more customized URL's is based on one or more of the following: transactions of said customer, said profile on said customer, response to previously transmitted one or more customized URL's and items to promote.

21. The system as recited in claim 19, wherein the computer program is further operable for performing the following programming steps:
retrieving information from said profile on said customer; and
establishing a connection with said hand held computer possessed by said computer in response to said retrieved information.

22. The system as recited in claim 19, wherein the computer program is further operable for performing the following programming step:
receiving a request with an appropriate identifier to establish a connection with said hand held computer possessed by said customer.

23. The system as recited in claim 22, wherein said appropriate identifier specifies a particular point of sale terminal, wherein said appropriate identifier comprises a port number and a terminal number.

24. The system as recited in claim 19, wherein said server comprises:
a processor; and
a memory unit coupled to said processor, wherein said memory unit is operable for storing a computer program operable for tracking an effectiveness of said one or more customized URL's.

25. The system as recited in claim 24, wherein the computer program of said server is further operable for performing the following programming step:
editing said profile of said customer in response to said tracking step

26. The system as recited in claim 19, wherein said one or more customized URL's comprise an identification of said customer.

27. A system, comprising:
a server configured to manage a database storing a plurality of profiles on a plurality of customers; and
a point of sale terminal coupled to said server, wherein said point of sale terminal comprises:
a processor; and
a memory unit coupled to said processor, wherein said memory unit is operable for storing a computer program operable for transmitting customized Uniform Resource Locator's (URL's) to a customer in a point of sale system, wherein the computer program is operable for performing the following programming steps:
receiving input from a customer identification card;
receiving a profile on a customer associated with said customer identification card; and
reading said profile on said customer;
wherein said server comprises:
a processor; and
a memory unit coupled to said processor, wherein said memory unit is operable for storing a computer program operable for:
determining one or more customized URL's to include in a file; and
transmitting said file to said point of sale terminal;
wherein the computer program of said point of sale terminal is further operable for performing the following programming step:
transmitting said file to a hand held computer possessed by said customer.
